(19) United States
(12) Patent Application Publication
(10) Pub. No.: US 2026/0354623 A1
(43) Pub. Date: Nov. 12, 2026

(54) DEVICE FOR CONTROLLING FOOD TEMPERATURE

(71) Applicants: Aryan Gorty, Skillman, NJ (US); Aishwarya Gorty, Skillman, NJ (US); Kavita Gorty, Skillman, NJ (US); Venkata Gorty, Skillman, NJ (US)

(72) Inventors: ARYAN GORTY, SKILLMAN, NJ (US); AISHWARYA GORTY, SKILLMAN, NJ (US); RAVI SAWHNEY, THOUSAND OAKS, CA (US); LANCE HUSSEY, THOUSAND OAKS, CA (US); CHRISTIANNA BETHEL, THOUSAND OAKS, CA (US); BRIAN WEINGARTH, THOUSAND OAKS, CA (US); MICHAEL KULICK, THOUSAND OAKS, CA (US); MICHAEL SCHUFFERT, THOUSAND OAKS, CA (US)

(21) Appl. No.: 19/673,310

(22) Filed: May 11, 2026

Related U.S. Application Data
(60) Provisional application No. 63/804,371, filed on May 12, 2025.

(51) Int. Cl. A47J 41/00; A47J 36/06; A47J 36/24; A47J 36/32; B65D 21/02; B65D 81/38; G01K 1/02; H05B 1/02

(52) U.S. Cl. CPC A47J 41/0072; A47J 36/06; A47J 36/2483; A47J 36/321; A47J 41/005; B65D 21/0228; B65D 81/3818; B65D 81/3823; G01K 1/026; H05B 1/0252; A47J 2202/00

(57) ABSTRACT

Described is a device for controlling food temperature. The device includes an insulated container having an interior volume configured to receive food. A lid is included to cover an opening of the interior volume and to provide thermal insulation for the interior volume. A hot module is attached to the insulated container. The hot module includes at least one heating element, a power supply, at least one temperature sensor configured to generate a signal indicative of a temperature associated with food in the interior volume, and temperature-regulating electronics. The temperature-regulating electronics are configured to control operation of the at least one heating element based at least in part on the signal from the at least one temperature sensor to regulate the temperature of food in the interior volume.

### CROSS-REFERENCE TO RELATED APPLICATIONS

The present application is a non-provisional application of U.S. Ser. No. 63/804,371, filed May 12, 2025, the entirety of which is incorporated herein by reference.

### BACKGROUND OF THE INVENTION

### (1) Field of Invention

The present invention relates to a device for controlling food temperature and, more particularly, to an insulated container having a lid and a heat module to change and/or maintain a desired temperature.

### (2) Description of Related Art

Many individuals opt to pack food for school or work instead of buying food from a restaurant or fast-food chain because it is often cost effective and healthier. Packing a meal or snack can be easy if the food item is not temperature sensitive.

However, packing temperature sensitive foods such as salads, meats or soups, any of which can spoil if not kept at a temperature range and are generally intended to be eaten hot or need to stay cold, can be extremely difficult if they are not stored in a cold environment or if the individual does not have any method of altering food temperature for ideal consumption. These problems are some of the most significant deterrents for individuals who want to take lunch or other meals with them.

The marketplace is devoid of products that are capable of both insulating to preserve food temperature and actively heating food to a desired temperature for consumption. Although portable food warmers and electric lunchboxes are capable of heating food, they are not designed to preserve food in an unrefrigerated environment for an extended period of time. Further, current products do not have a separate container and detachable module that assists in keeping food at a temperature range and/or changing the temperature.

Thus, a continuing need exists for a temperature-regulating food container and temperature-altering device that integrates highly effective insulating and temperature-regulating technologies, as well as a completely new, innovative, and simplified architecture. Such a device would be ideal for individuals such as students, office workers, outdoor enthusiasts, and construction workers who prefer to pack their own food but don't have access to a refrigerator or microwave to bring food to the ideal temperature for consumption.

### SUMMARY OF INVENTION

The present disclosure provides an insulated container and, more particularly, to a device for controlling food temperature. The device includes a first insulated container having an interior volume configured to receive food. The insulated container includes an inner wall, an outer wall spaced from the inner wall to define an insulating cavity therebetween, and a bottom wall defining at least a portion of a floor of the interior volume. A lid is included that is configured to be removably coupled to the insulated container to cover an opening of the interior volume and to provide thermal insulation for the interior volume. The device also includes a hot module. The hot module includes at least one heating element, a power supply configured to supply electrical power to the at least one heating element, at least one temperature sensor configured to generate a signal indicative of a temperature associated with food in the interior volume, and temperature-regulating electronics operatively coupled to the at least one heating element, the at least one temperature sensor and the power supply. The temperature-regulating electronics are configured to control operation of the at least one heating element based at least in part on the signal from the at least one temperature sensor to regulate the temperature of food in the interior volume.

In another aspect, the insulating cavity is at least one of (a) a vacuum cavity, and (b) filled with a thermal insulation material.

In yet another aspect, the hot module is configured to be selectively attached to a connection cavity formed in a base of the insulated container.

In yet another aspect, the connection cavity and the hot module include complementary threaded portions configured to releasably secure the hot module to the insulated container.

Further, the temperature-regulating electronics are configured to: receive a target temperature;
compare the target temperature to a temperature determined from the signal from the at least one temperature sensor; and
control the at least one heating element to maintain the temperature of the food within a predetermined range of the target temperature.

In yet another aspect, the temperature-regulating electronics are configured to execute a scheduled heating operation including:
determining a start time for heating based on an initial temperature associated with the food, and
energizing the at least one heating element beginning at the start time so that the food reaches a target temperature at a user-specified time.

In yet another aspect, the temperature-regulating electronics are configured to operate the at least one heating element at a first power level for a pre-heating interval prior to a scheduled consumption time and at a second, lower power level to maintain the temperature of the food thereafter.

In another aspect, a wireless transceiver is operatively coupled to the temperature-regulating electronics and configured to communicate wirelessly with a remote mobile device.

Further, the temperature-regulating electronics in conjunction with the wireless transceiver are configured to:
receive from the remote mobile device at least one of a target temperature, a heating schedule, or an operating mode; and
transmit to the remote mobile device at least one of a measured temperature, a battery status, or a heating status.

In yet another aspect, the device includes a second insulated container having an insulated interior that is configured to receive food. The first insulated container and second insulated container are configured to be selectively connected with one another. Additionally, in this aspect, the at least one heating element includes a first heating element connected to the first insulated container and a second heating element connected to the second insulated container. Further, the at least one temperature sensor is a first temperature sensor connected to the first insulated container and a second temperature sensor connected to the second insulated container, such that the temperature-regulating electronics are configured to separately control operation of the first and second heating elements based at least in part on the signals from the first and second temperature sensors. Additionally, a bottom part of the hot module includes electrical contacts that are configured to electrically connect with contacts formed on a top part of the first insulated container, while electrical contacts formed on a bottom of the first insulated container electrically connect with contracts formed on a top part of the second insulated container.

Finally, the present invention also includes a method for forming and using the device as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an isometric-view illustration of a device for controlling food temperature according to various embodiments of the present invention, depicting the device having a container with an insulated lid and an attachable heating/temperature maintaining module;

FIG. 2 is an exploded-view illustration of the device according to various embodiments of the present invention;

FIG. 3A depicts a cross-sectional, side view of the device according to various embodiments of the present invention;

FIG. 3B is an illustration of device according to various embodiments of the present invention;

FIG. 3C is an exploded-view illustration of a lid according to various embodiments of the present invention;

FIG. 3D is an exploded-view illustration of a hot module according to various embodiments of the present invention;

FIG. 3E is an exploded-view illustration of a cold module according to various embodiments of the present invention;

FIG. 3F is an exploded-view illustration of an electronics assembly according to various embodiments of the present invention;

FIG. 4A is a top-isometric view illustration of a device for controlling food temperature according to another aspect of the present invention;

FIG. 4B is a bottom-isometric view illustration of the device according to another aspect of the present invention;

FIG. 5 is a top, exploded-view illustration of the device according to another aspect of the present invention;

FIG. 6 is a bottom, exploded-view illustration of the device according to another aspect of the present invention;

FIG. 7 is a schematic, side cross-sectional view of the device according to another aspect of the present invention;

FIG. 8 is a schematic side cross-sectional perspective view of the device according to another aspect of the present invention;

FIG. 9 is a schematic, exploded-view of a hot module according to another aspect of the present invention;

FIG. 10 is a schematic, rear, exploded-view of a hot module according to another aspect of the present invention;

FIG. 11 is a schematic, perspective, cross-sectional view of a hot module according to another aspect of the present invention;

FIG. 12 is a schematic, side, cross-sectional view of a hot module according to another aspect of the present invention;

FIG. 13 is a schematic, perspective-view of a container according to another aspect of the present invention;

FIG. 14 is a schematic, exploded-view of the container according to another aspect of the present invention;

FIG. 15 is a schematic, rear, exploded-view of the container according to another aspect of the present invention;

FIG. 16 is a schematic, perspective, cross-sectional view of the container according to another aspect of the present invention;

FIG. 17 is a schematic, side, cross-sectional view of the container according to another aspect of the present invention;

FIG. 18 is a schematic, perspective-view of a container according to another aspect of the present invention; and

FIG. 19 is a schematic diagram illustrating communication between electronic devices and a container according to another aspect of the present invention.

### DETAILED DESCRIPTION

The present invention relates to a device for controlling food temperature and, more particularly, to an insulated container having a lid and a hot module to change and/or maintain a desired temperature. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

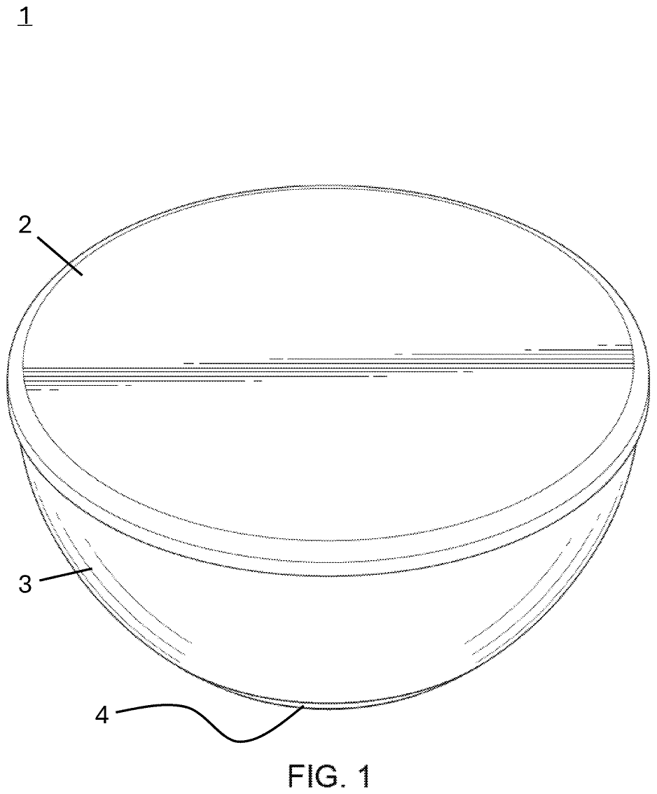

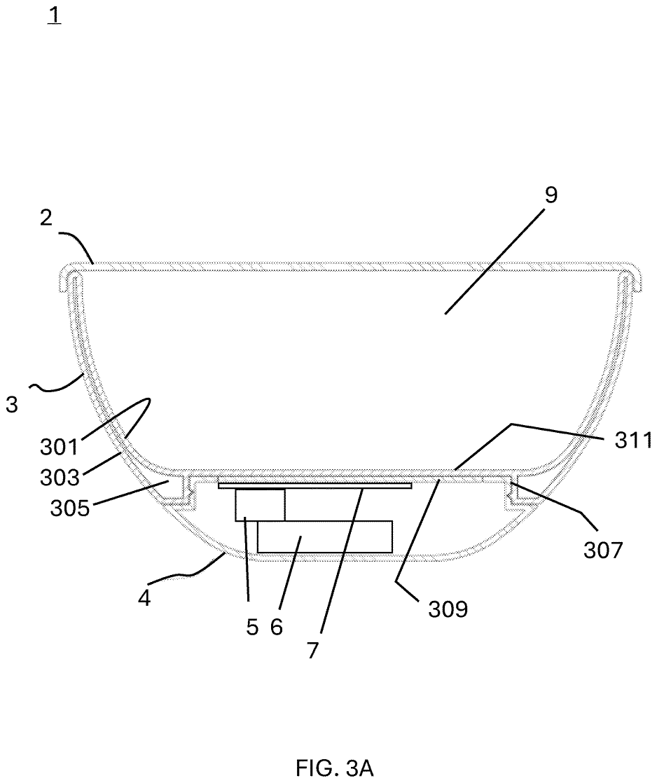

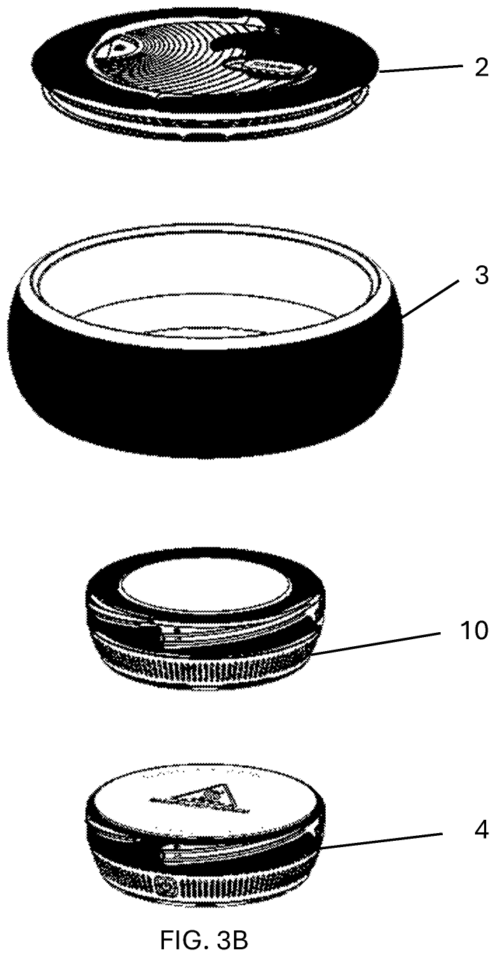

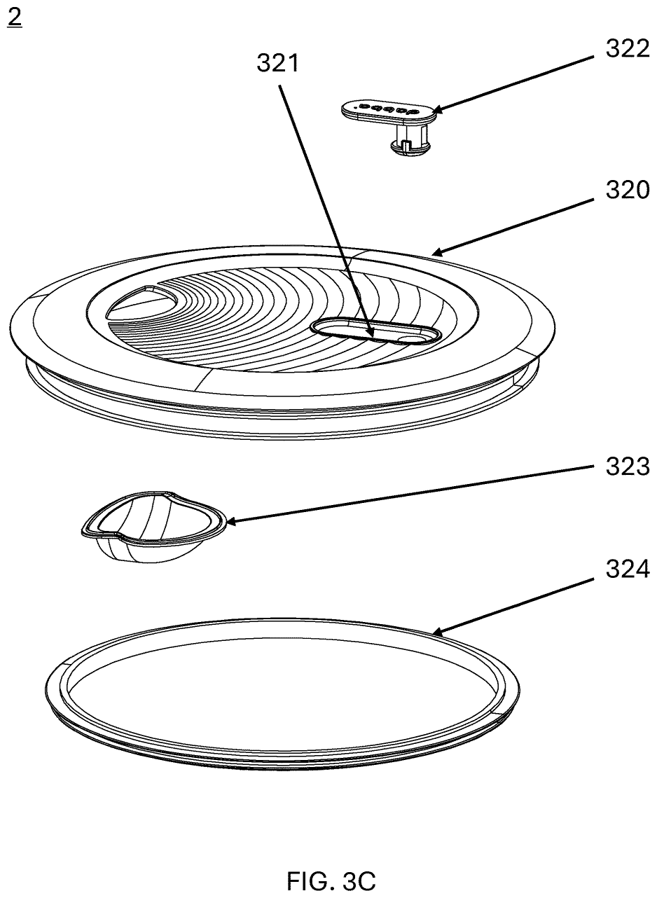

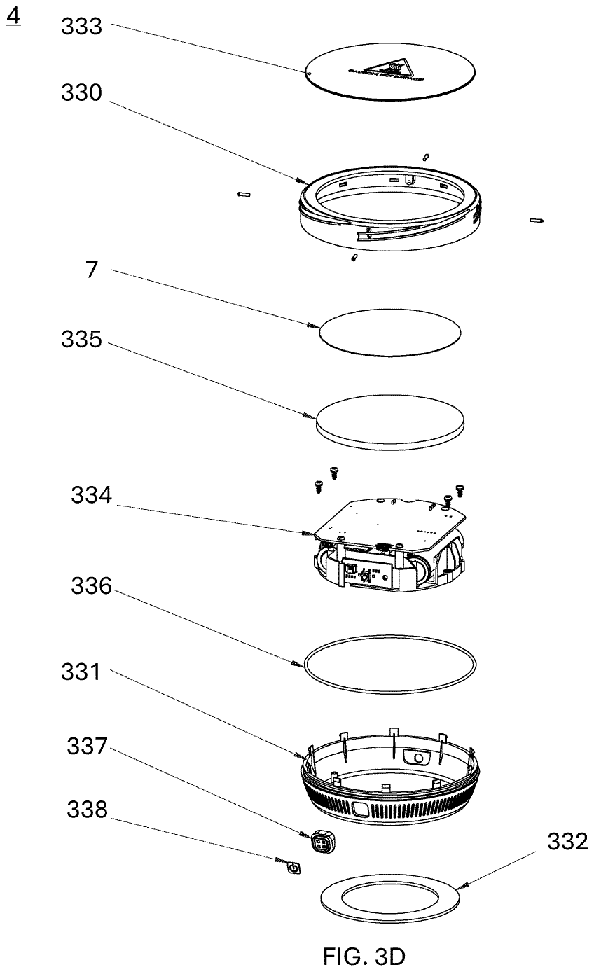

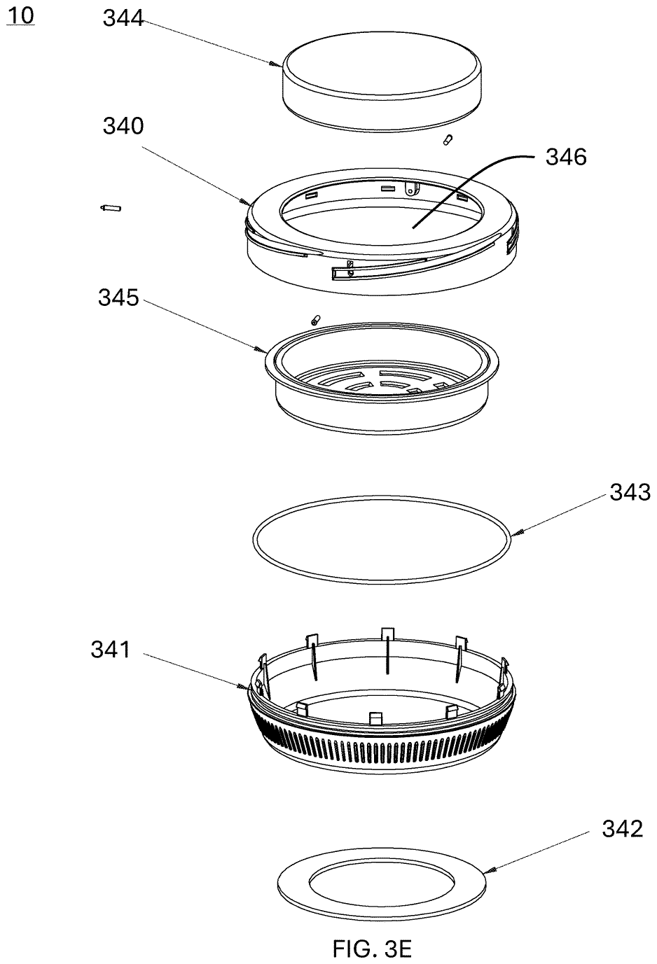

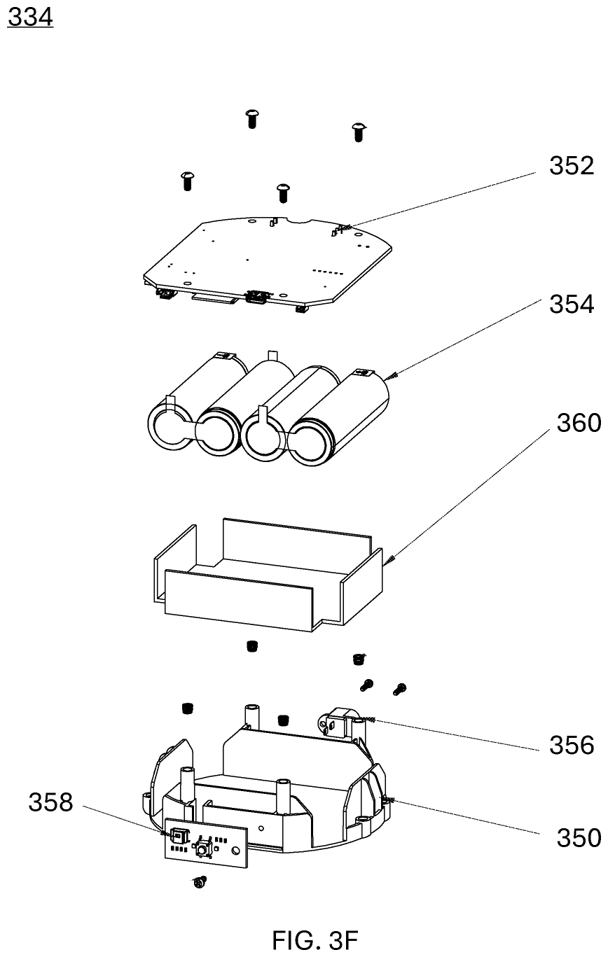

As described herein and illustrated throughout the figures, the present disclosure provides a device 1 configured for controlling and regulating the temperature of food. As shown in FIG. 1, the device 1 includes an insulated container 3 having a lid 2 and a hot module 4 that is operable to change and/or maintain a desired temperature. In operation, a user places hot or cold food into the container 3 and covers the top with the insulated lid 2 while operating the hot module 4 as desired. When used in this manner, the device 1 maintains the temperature of the food for an extended period, such as over the course of a day. When the user is ready to eat, the user can activate the hot module 4 and set it to a desired temperature or temperature range. When the food reaches the ideal or desired consumption temperature, the hot module 4 may automatically turn off and/or enter a maintaining mode in which it keeps the contents within a preferred temperature range, thereby allowing the user to consume the food at a comfortable temperature. Optionally and as shown in FIG. 3B, a dedicated cooling or cold module 10 can be used in combination with, or in place of, the heating functionality to keep food chilled for a longer duration.

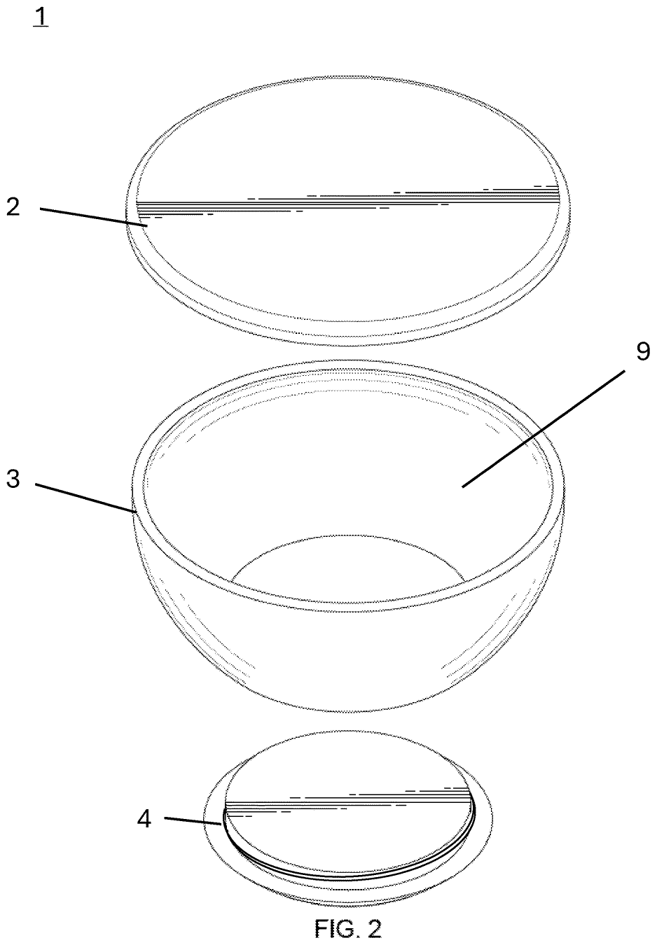

As shown in FIGS. 1 through 3F, the device 1 includes three or more primary components: the insulated lid 2, the insulated container 3, and the temperature-changing/maintaining module (i.e., hot module 4). Each of these components may be formed in various shapes and sizes and may be adapted to different use environments (e.g., household, office, outdoor, travel). Desirably and as noted above and shown in FIG. 3B, the device 1 also includes a cold module 10. The structural and functional features of each component are described in further detail below.

The insulated lid 2 is configured to cover and seal the contents of the container 3, thereby assisting in maintaining the internal temperature of the contents and reducing heat transfer to or from the surrounding environment. The insulated lid 2 may be formed in any suitable manner and from any suitable material to provide sufficient insulating capabilities and mechanical durability. Non-limiting examples of such lid configurations include a molded plastic lid and a metal shell having an internal vacuum cavity. The lid 2 can further include sealing elements such as gaskets, O-rings, or flexible rims to improve the air-tightness or liquid-tightness of the seal between the lid 2 and container 3. As can be appreciated by those skilled in the art, the lid 2 may be manufactured using a variety of methods (e.g., injection molding, stamping, welding, adhesive bonding) and may be configured with different geometries, finishes, and decorative features as desired and/or as applicable to the particular final design of the device 1.

One non-limiting example of the lid 2 is depicted in FIG. 3C. In this exploded-view illustration, the lid 2 is formed of a primary lid cover 320 having an aperture 321 formed to affix with a vent plug 322. A pocket 323 is also included that operates as a handle to affix with the primary lid cover 320. Finally, a gasket or seal 324 is affixed with the lid cover 320 to allow the lid 2 to seal against the container 3.

The container 3 is formed in any suitable manner to provide an insulating effect to the contents therein and to withstand repeated use, including temperature cycling, washing, and mechanical handling. Preferably, the container 3 is formed as a double-walled insulated container having an interior volume 9 configured to receive food. As shown in FIG. 3A, the container 3 provides double-wall insulation, either via vacuum insulation or physical insulation, such that an internal wall 301 and an external wall 303 are separated by a hollow space 305 to form an insulating cavity. The hollow space 305 may be evacuated to form a vacuum void or may be filled with an insulating material such as foam, fibers, aerogel, or other thermally insulating media. The double-wall construction helps reduce heat transfer by conduction, convection, and radiation, thereby improving the device's ability to keep hot foods hot and cold foods cold for extended periods. The container 3 may be cylindrical, rectangular, or of any other suitable shape and may be provided in multiple capacities (e.g., single-serving, family-size) to suit different user needs.

As noted above, a unique aspect of the device 1 is its ability not only to insulate but also to actively and effectively regulate the internal temperature of the container 3. To accomplish this active temperature regulation, the device 1 desirably includes a hot module 4 that can be selectively connected to the container 3. As one example, the container 3 is formed to have a connection cavity 307 at its base to allow for selective attachment and detachment of the hot module 4. The connection cavity 307 may be recessed, threaded, keyed, or otherwise shaped to ensure proper alignment and secure engagement. To facilitate optimal heat transfer between the hot module 4 and the food contents, when the hot module 4 is connected to the container 3 via the connection cavity 307, a top portion 309 of the hot module 4 is brought into direct or closely spaced contact with a bottom wall 311 of the container 3. Preferably, as shown in the cross-sectional view of FIG. 3A, the floor 311 or bottom wall of the container 3 is formed as a single wall, in contrast to the double side walls 301 and 303. This single-wall bottom construction reduces thermal resistance and promotes efficient heat transfer from the hot module 4 to the interior of the container 3 while maintaining good insulation along the sides.

As further noted above, the hot module 4 is formed to selectively attach to the cavity 307 of the container 3. Attachment may be accomplished with any suitable locking mechanism, such as a bayonet-style coupling, snap-fit, latch, magnetic coupling, or threading. A non-limiting example includes threaded engagement, in which threads formed around a periphery of the hot module 4 screw into corresponding threads formed in the walls of the cavity 307. Such threaded attachment can provide a secure and stable mechanical connection and can also help ensure intimate contact between the top portion 309 of the module 4 and the bottom wall 311 of the container 3. When attached and operated, the hot module 4 is pressed against or biased toward the bottom wall 311, thereby transferring generated heat (or absorb heat in the case of cooling functionality) to maintain or adjust the temperature of the contents of the container 3. The interface between the module 4 and container 3 may optionally include thermal interface materials (e.g., pads, greases, coatings) to improve thermal conduction.

To perform the desired temperature-regulation function, and as understood by those skilled in the art, the hot module 4 includes any necessary components required to set, change, and/or control a desired temperature profile. By way of non-limiting example, the hot module 4 includes temperature-regulating electronics 5 (e.g., integrated circuits, printed circuit boards (PCBs), microcontrollers, control components such as a Bluetooth® transceiver, thermometers, thermistors, or other sensors), a power supply 6 (e.g., a rechargeable battery, removable battery pack, supercapacitor, or combination thereof), one or more heating elements 7, and optionally one or more phase change materials or heat spreaders to stabilize or redistribute thermal energy. Thus, in some aspects, the temperature-regulating electronics 5 are housed within the hot module 4 and are configured to actuate (turn on, modulate, and/or shut off) the heating element 7 via preset temperatures and times and/or when the sensed temperature falls outside a predetermined temperature setting or range (for example, within about ±3 degrees of a set temperature). The electronics may implement closed-loop control algorithms (such as PID control or hysteresis-based control) to improve accuracy, reduce overshoot, and enhance energy efficiency.

Further, as noted above, one or more control components are communicatively connected to the hot module 4 to allow for selective control by the user. The control components may include any devices necessary to receive user commands and to control the operating state of the hot module 4. Non-limiting examples include mechanical or capacitive buttons, a keypad, a liquid crystal display (LCD) or other visual display, an array of indicator lights, and a wireless transceiver for communicating with external devices. Using these control components, the user is able to power the hot module 4 on or off, select or adjust variable temperature settings, set timers or schedules, choose operating modes (e.g., “keep warm,” “reheat,” “chill”), and view status information (e.g., current temperature, battery level, connection status). The control components can be located on the hot module 4 itself, on the container 3, and/or on a remote device communicating wirelessly with the module 4.

In one aspect, and as can be appreciated by those skilled in the art, the device 1 provides a system with a temperature control function for actively heating refrigerated (or non-refrigerated) food to a desired temperature at a desired time. For example, a user can place cooked food inside the container 3 (e.g., a metal container insert) and store it in a refrigerator, freezer, or other cooled environment for a prolonged period without substantial alteration of its quality. On the desired day of consumption, the container 3 can be combined with the electronic hot module 4 and programmed such that the module 4 turns on and heats to the desired temperature at a scheduled time of use. In one scenario, the device 1 can be placed on a countertop or desk, and the user can program the module 4 in the morning to ensure that the food reaches the desired serving temperature by lunchtime. As a non-limiting example, the hot module 4 can be configured to operate at a higher power level for about 30 minutes before the scheduled time, thereby rapidly elevating the food temperature while reducing the total time the food remains at room temperature, which can help reduce the likelihood of food deterioration or contamination at ambient conditions. The system may also be used to gently reheat food over a longer period or to maintain temperature once the target temperature has been reached, thereby enhancing convenience and flexibility.

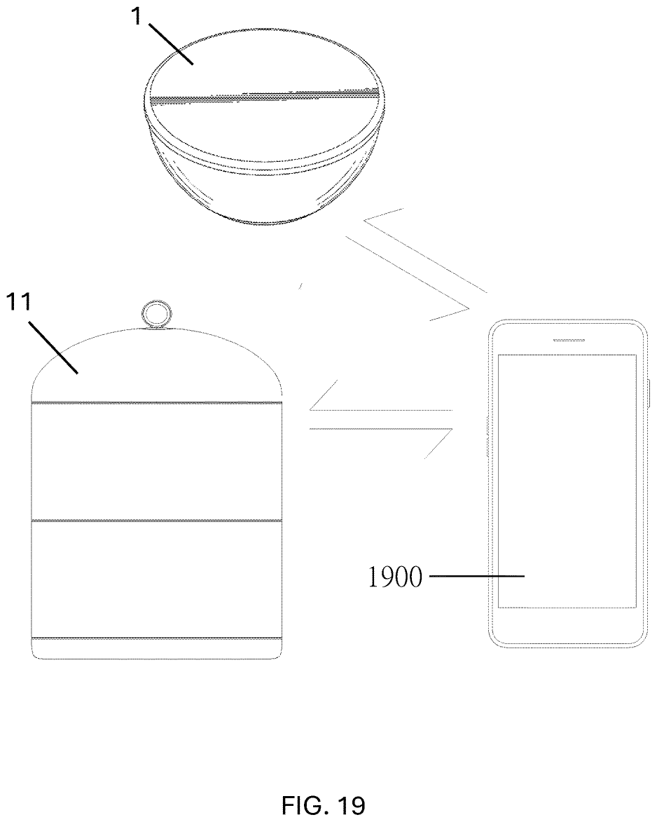

Desirably, the user may wirelessly input control commands, such as a specific set temperature, a desired temperature profile, and/or a heating time, to the hot module 4 and monitor state information of the device 1. As noted above, the control components can include a transceiver (e.g., WI-FI™, BLUETOOTH®, ZIGBEE™, IR, or RF transceiver) for transmitting information to and receiving information from a remote device. As shown in FIG. 19, the remote device is a mobile device 1900 that can be paired or synchronized via Bluetooth® or similar technology and can be, for example, a smartphone, personal digital assistant (PDA), tablet computer, laptop, notebook computer, or other suitable computing device. A dedicated mobile application (for example, an iOS®, Android™, or Windows® mobile application) may be installed on the mobile device 1900 and configured to pair with the device 1 to allow wireless control. Through this application, the user may set parameters such as target temperature, heating schedule, container selection (in a multi-container embodiment), and notification preferences. The wireless transmitter or transceiver within the hot module 4 is configured to establish a communication connection with the mobile device 1900 and is further configured to send detected temperature data, battery status, timing information, and other related parameters to and from the mobile device 1900. In this manner, the user can remotely monitor the cooking or warming process and receive alerts when the food has reached the desired state.

A non-limiting example of the hot module 4 incorporating the various components above is illustrated in FIG. 3D. In this example, the hot module 4 includes a housing formed of an upper housing 330 that seals against a lower housing 331, with an O-ring 336 providing a water resistant seal therebetween. A rubber base, non-slip pad 332 is affixed to the bottom of the lower housing 331, whereas a heat plate 333 is affixed to the top of the upper housing 330. A heating element 7 (e.g., polyimide flex coil, 100 mm diameter, 12 V, 60 W, 3.4 ohm, or any other suitable heating element) is positioned against the heat plate 333 to heat the heat plate 333 without damaging the heating element 7.

An electronics assembly 334 is included to house the various electronic components as described herein. A heating element insulator 335 (e.g., rubber, foam, or any other suitable insulating material) can be positioned between the electronics assembly 334 and heating element 7 to prevent the housed electronic components from overheating due to proximity of the heating element 7. As described herein a button 337 (and button cover 338) or other actuator is included to turn on and activate the hot module 4.

For further understanding, an exploded view of the electronic assembly 334 is provided in FIG. 3F. The electronics assembly 334 operates as one example of the temperature controlling electronics 5 a power supply 6 referenced above. This non-limiting example of an electronic assembly 334 includes a battery housing 350, a main printed control board assembly (PCBA) 352, a battery 354 (e.g., rechargeable or disposable), a power jack 356, an LED and PCBA switch 358, and battery cushioning/insulation 360. Also shown are the various screws and fasteners to seal and secure the electronics assembly 334

As noted above and as further illustrated in FIG. 3E, a dedicated cooling or cold module 10 can be used to keep food chilled for a longer duration. The cold module 10 can be formed of any suitable components to maintain and transfer a cold temperature to the container 3. As a non-limiting example an as shown in the exploded-view illustration of FIG. 3E, the cold module 10 includes an upper cold module housing 340 that seals against a lower cold module housing 341 using an O-ring 343. As was the case above, a rubber non-slip base 342 can be affixed to the bottom surface of the lower cold module housing 341. A cold puck 344 nests within a middle housing 345 and is sealed within the cold module 10. The upper cold module housing 340 has an aperture 346 formed therethrough such that a portion of the cold puck 444 passes through the aperture for contact and/or proximity with the container 3 to cool the container 3.

The cold puck 344 is formed of any suitable material to maintain a cool temperature. As a non-limiting example, the cold puck 344 is a sealed container having a gel sealed therein. Freezing the gel cools the cold puck 344 and allows the cold puck to maintain cold for an extended period of time. As yet another example, the cold puck 344 is a sealed container having water therein. Freezing the cold puck 344 causes the water to turn to ice and maintain the cold puck in a cooled state as the ice melts. Thus and as can be appreciated by those skilled in the art, there are a variety of techniques by which the cold puck 344 itself can be formed to maintain a cooled temperature.

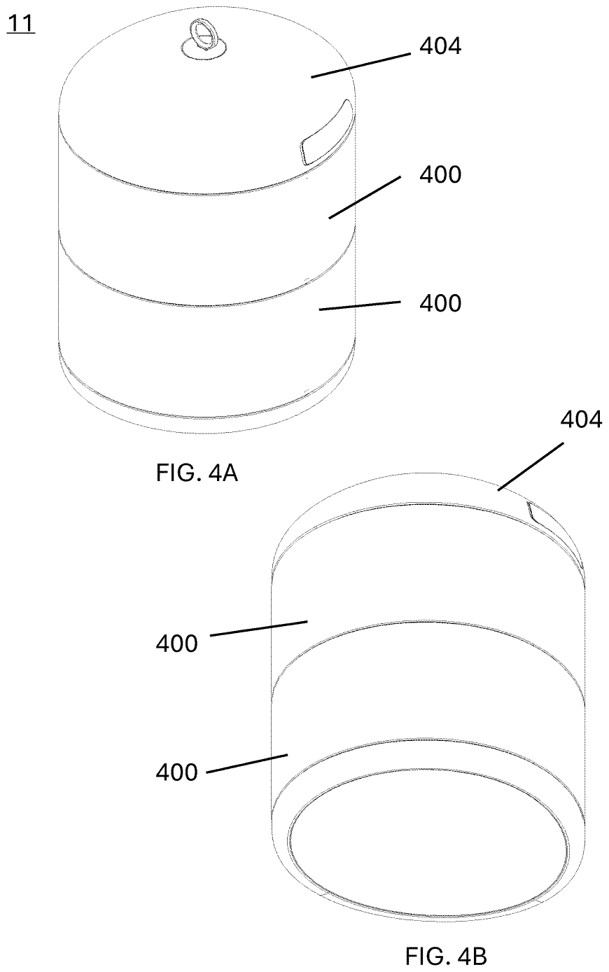

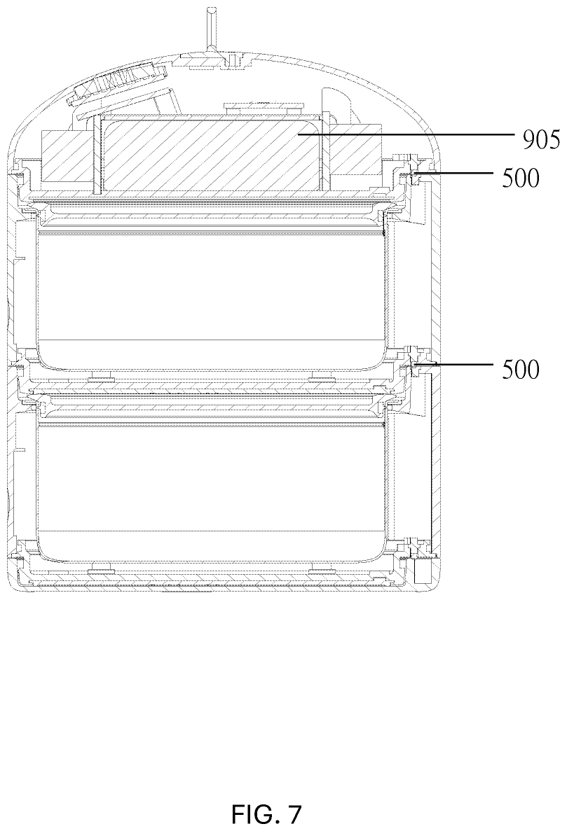

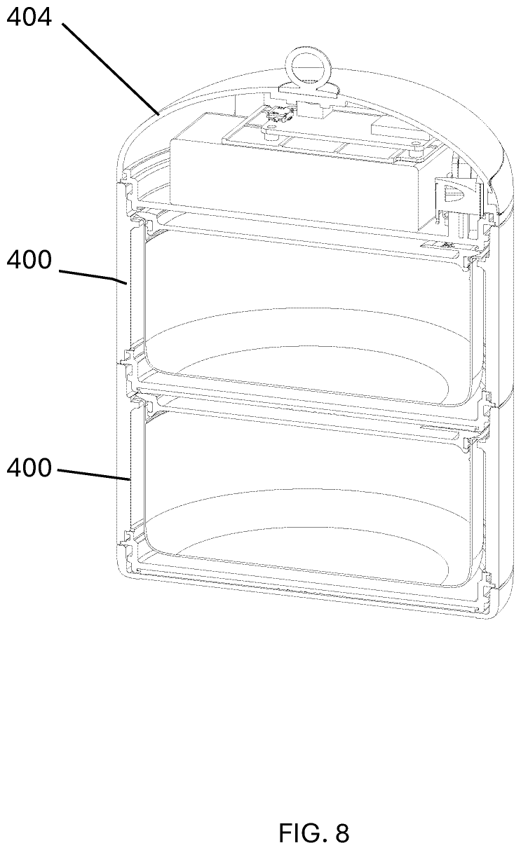

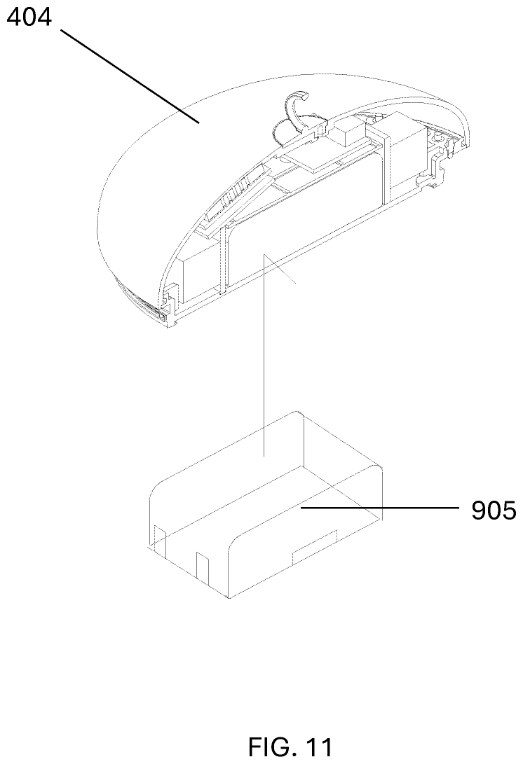

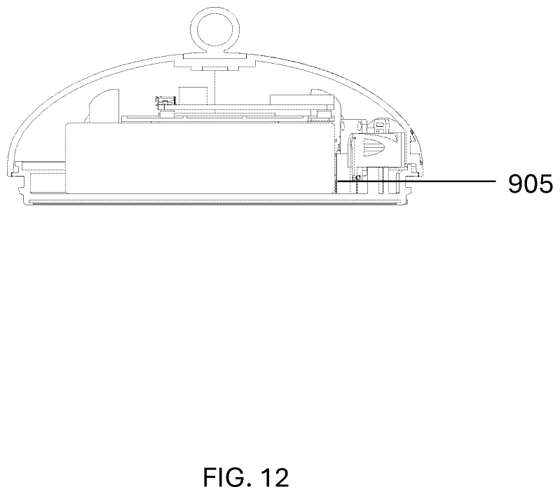

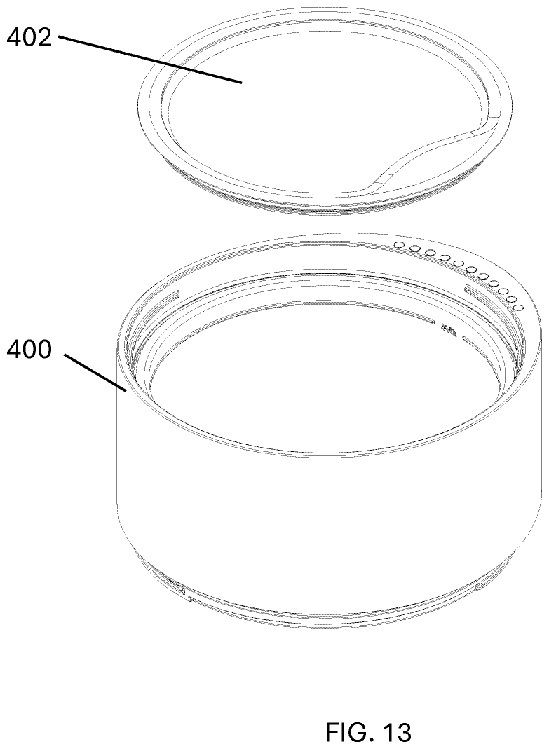

Another aspect of the present invention is depicted in FIGS. 4A through 19.

While FIGS. 1 through 3F depict an embodiment having a single container 3, the device 1 can be extended to include multiple containers with additional functionality as depicted in FIGS. 4A through 19. In this multi-container embodiment, multiple containers can be stacked, nested, or otherwise mechanically coupled together and used in conjunction with a common hot module. Thus, the components described above with respect to FIGS. 1 through 3F—such as the container, lid, and hot module—can be similarly applied to the multi-container aspect illustrated in FIGS. 4A through 19, and features described in the multi-container embodiment can likewise be applied to the single-container embodiment, as applicable and understood by those skilled in the art.

When applied to multiple containers (as shown in FIGS. 4A through 19), each container 400 can be used to contain a different kind of food. In many practical situations, different foods require different heating temperatures or time profiles to achieve optimal taste and texture. For example, soup may be best served at a higher temperature than a salad or dessert. Thus, in some aspects, each food stored in a corresponding container 400 may have its own appropriate heating temperature, and, according to individual taste, a particular desired heating temperature can be selected. Therefore, in one aspect, the device 11 can be used to contain different foods in several containers 400 and to individually set the heating temperature for each container so that each container reaches its own target temperature at a desired time. This enables a flexible, multi-course meal preparation system in which each dish is brought to an appropriate serving temperature on a coordinated schedule.

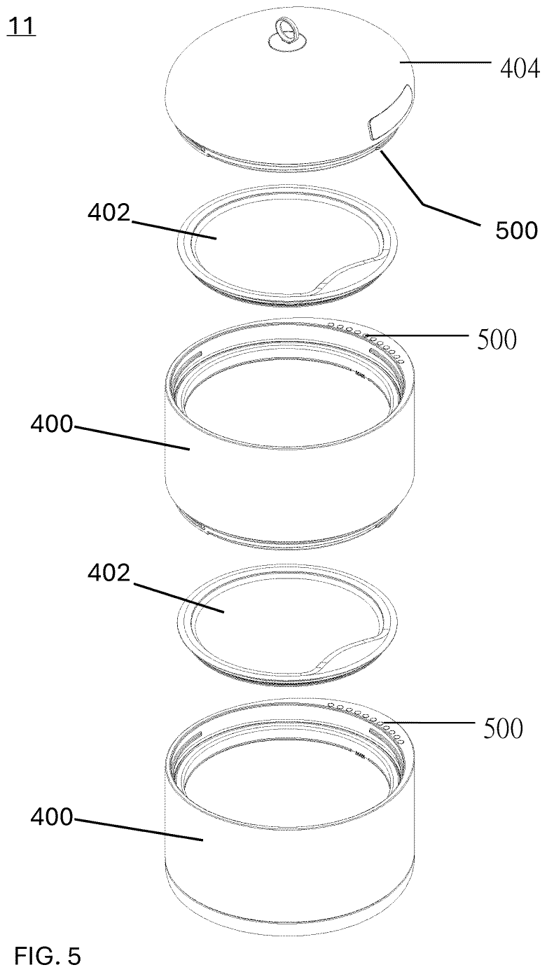

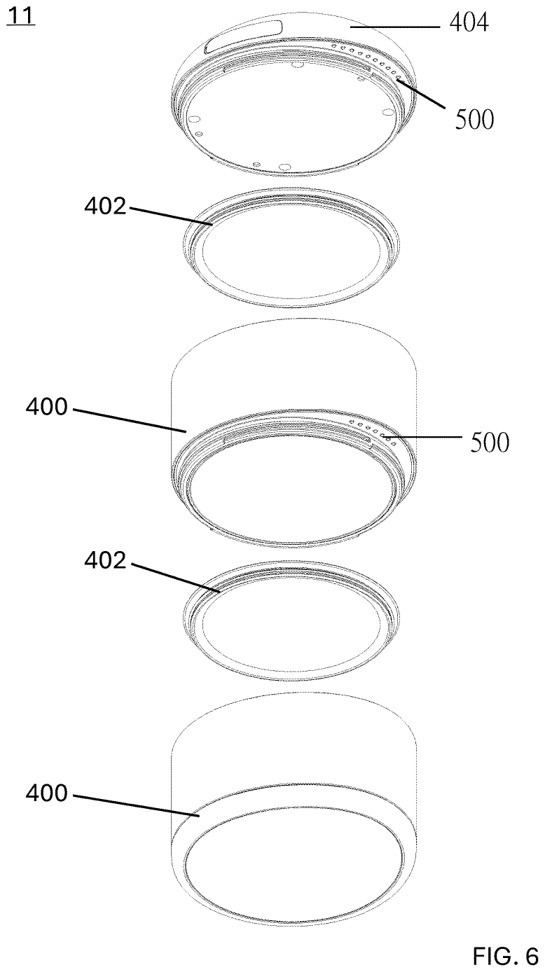

In this multi-container aspect, and as shown in FIGS. 5 and 6, the device 11 includes multiple containers 400, each having its own lid 402. When connected, and as shown in FIGS. 4A and 4B, the containers 400 nest or stack together to form a multi-container assembly that can be transported and stored as a unit. The hot module 404 is configured to interface with one or more of the containers 400 so that different food products can be heated to different temperatures and/or at different times. In some embodiments, the user can control each container individually via a user interface or mobile application, or can select predefined programs (e.g., “multi-course lunch,” “kids'meal,” etc.) that specify different target temperatures for respective containers.

In contrast to the embodiment shown in FIGS. 1 through 3F, the multi-container device 11 of FIGS. 4A through 19 distributes some of the heating and sensing components out of the central hot module 404 and across the individual containers 400. For example, and as discussed in further detail below, the heating elements 406 are positioned within or adjacent to the containers 400 themselves while being communicatively connected to and controlled by the hot module 404 via contact terminals 500. During operation, a first container 400 is detachably connected with a second container 400 (e.g., stacked one on top of another). The top or first container 400 is also detachably connected with the hot module 404. The components can be attached, for example, with threads to allow rotational connection, or with bayonet couplings, snap-latches, or other reversible fastening mechanisms. This modular arrangement allows the user to easily add or remove containers from the stack and to customize the number of containers used.

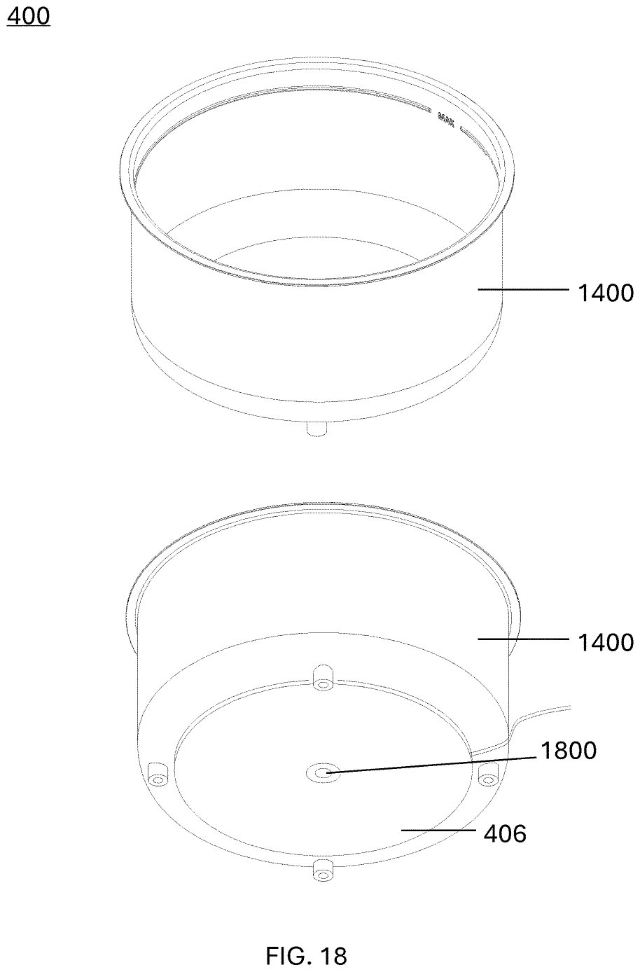

In some aspects, the containers 400 are formed from a metal container or insert capable of holding food, with an open top and an interior chamber defined by a wall spaced around a predetermined volume. The hot module 404 supplies and controls power to the containers 400 to bring the temperature in the metal containers to a target temperature at a set time. Thus, the system can be operated while power and electrical signals are transmitted through contact terminals 500 to the heating elements 406 (shown in FIG. 18). This arrangement allows the hot module 404 to function as a central control unit and power source, while the containers 400 effectively function as individual “heating zones.”

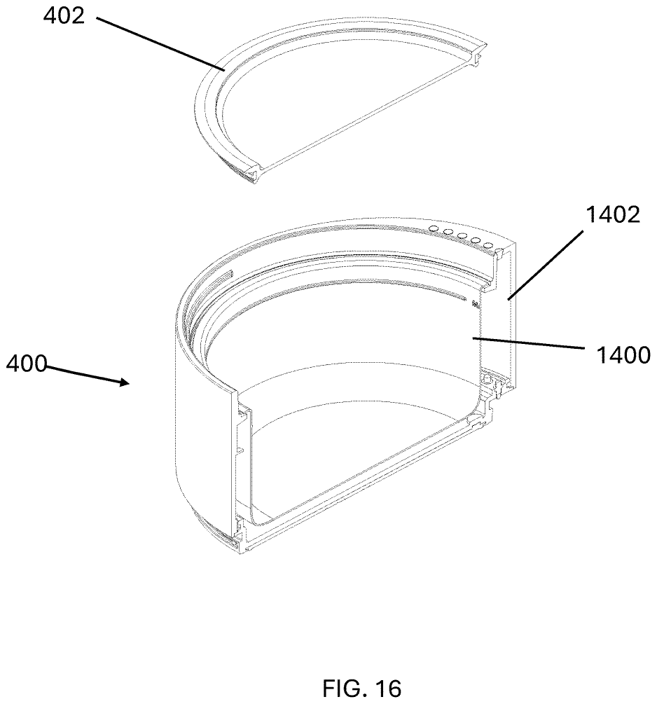

With respect to the containers 400, and as shown in FIG. 16, they can be formed from any suitable materials. For example, each container 400 may include a metal inner wall 1400 that is press-fitted into, or otherwise sealed against, an outer wall 1402 made from a different material, such as a plastic or composite. As shown in FIG. 18, a heating element 406 and a temperature sensor 1800 are attached to the bottom side of the container inner wall 1400 or the container 400. The heating element 406 may be a heater wire, resistive element, or any other suitable heating component (e.g., a flexible printed heater, PTC element, or metal foil heater) for heating the metal portion of container 400. In one aspect, the heating element 406 at the bottom of the container 400 forms a circular-shaped heating zone, but other shapes such as serpentine, radial, or segmented configurations may also be used. The temperature sensor 1800 may include one or more sensors configured to contact or closely interface with the outer surface of the metal container 400 to sense the temperature change of food in the container 400. In some embodiments, the sensor is thermally coupled to the container bottom or side walls to approximate the internal food temperature.

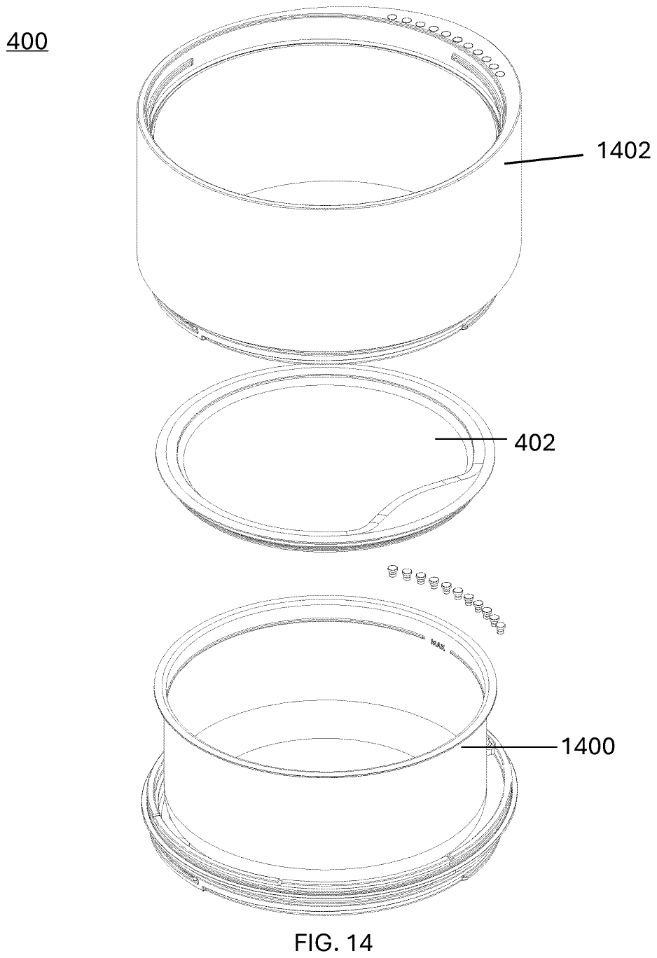

In some aspects, the outer surface of the metal container 400 and the heating element 406 are covered with insulating material. As shown in FIG. 14, the container 400 can be formed of an inner wall 1400 of a metallic material (for example, stainless steel or surface-treated aluminum) and an outer wall 1402 of a plastic material such as polypropylene, polycarbonate, or another food-safe polymer. The insulating layer between the metal inner wall and the plastic outer wall reduces heat loss and helps keep the outer surface cooler to the touch. The upper part of the container 400 is open to receive food but can be temporarily closed by covering the opening with the middle lid 402 formed of any suitable material (e.g., elastic, silicone, rubber, or plastic material). Inside the metal container 400, there is a food-storage space that may be smooth or partitioned and may optionally include internal structures such as ridges or dividers to assist with portioning or mixing.

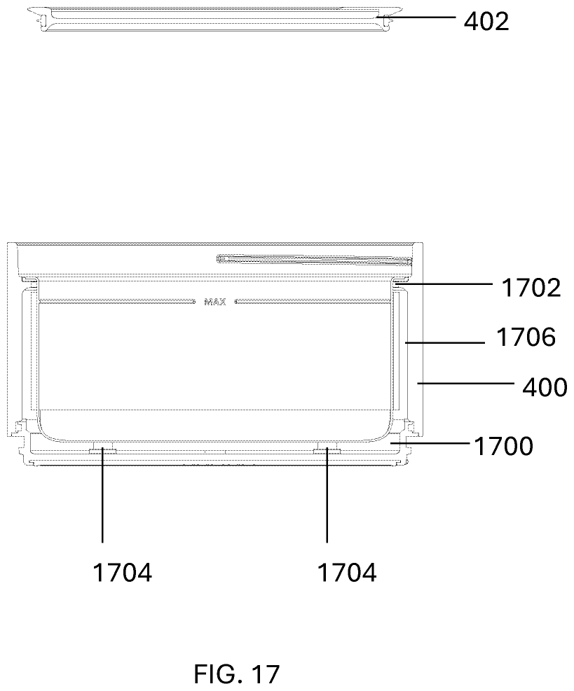

In one aspect, and as shown in FIG. 17, the upper part of the metal container 400 combines a soft silicone ring 1702 that enhances sealing and provides a comfortable gripping surface. The lower part of the container 400 is welded or otherwise joined with a fastening nut part 1704 and is fastened with a screw from the outside of the surrounding wall to form a waterproof seal for an annular chamber structure 1706. The chamber structure 1706 is a cavity formed between the inner wall and surrounding wall, which serves as an insulating barrier and may also house wiring, sensors, or support structures as needed.

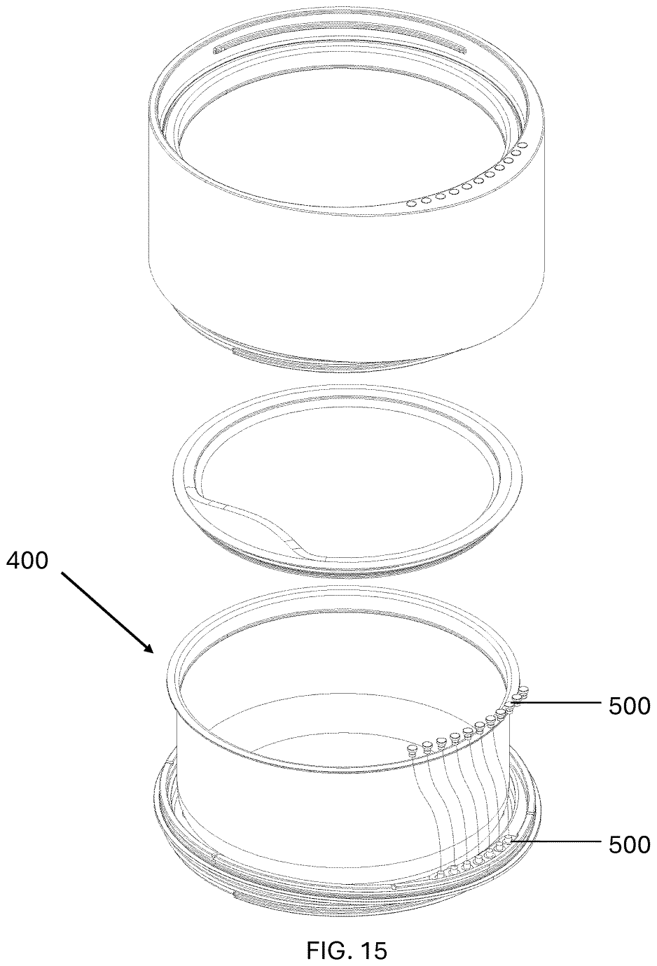

As noted above, the containers 400 can be connected with one another to provide electrical power and communication signals across the containers 400 to the various heating elements 406 and sensors 1800. To facilitate this, and as shown in the exploded-view illustration of FIG. 15, corrosion-resistant electrical contacts 500 are arranged on the ceiling and bottom surfaces of each container section. The electrical contacts 500 are sized and shaped to contact corresponding electrical contacts on the hot module 404 and on adjacent container sections 400 when stacked or nested. In the upper part of each container 400, there is at least one electrical contact 500 for receiving power and sending information signals from the hot module 404 or from a container 400 coupled above. The lower part of each container 400 also has electrical contacts 500 for supplying power to, and obtaining information from, the container 400 coupled below. In some aspects, the electrical contacts 500 at the bottom of the hot module 404 and at the top and bottom of each container 400 protrude from the surface in the form of raised pads or posts and may include gold plating or other corrosion-resistant coatings. Thus, the electrical contact 500 at the bottom of the hot module 404 corresponds to the electrical contact at the top of the first container 400, and the electrical contact 500 at the bottom of the first container 400 corresponds to the electrical contact at the top of the second container 400 nested with the first container 400, and so on. This creates a daisy-chain configuration that passes power and signals through the stack.

Temperature sensors 1800 are used to control the heating elements 406 in a feedback-controlled manner. Even when the heating system is not actively delivering power, the sensors may continue to monitor the temperature of the food in the container 400 so that the system can accurately predict the required heating duration and start time to reach the set temperature at the scheduled time. In one aspect, the temperature sensor 1800 is placed at a position spaced laterally from the heating element 406 so that the temperature reading is not unduly biased by localized heater temperatures and instead provides a closer approximation of overall food temperature. The measured temperature is used to determine when to power the heating element 406 on and off and to refine the heating profile over time. As a non-limiting example, factory preset temperature ranges may be provided, such as low (approximately 68 °F rise relative to room temperature), medium (approximately 77 °F rise relative to room temperature), and high (approximately 86 °F rise relative to room temperature). The user can override or reset these temperatures through the mobile application or local controls to better match personal preferences. In one aspect, and as understood by those skilled in the art, since the thermal conductivity and thermal mass vary depending on the type of food (e.g., liquid, semi-solid, solid), the food temperature in the container 400 can be estimated by applying a calculation formula or algorithm to the value detected by the temperature sensor 1800, optionally taking into account the container geometry, material properties, and historical heating data.

The heating element 406 disposed at the bottom of the metal container 400 is powered to provide heat to the food inside the container 400 by using the thermal conductivity of the metal inner wall. In some aspects, the container 400 has a plurality of heating elements 406, each of which may be associated with a particular section of the container (e.g., a quadrant, half, or localized region). In such aspects, the container 400 can be operated as multiple independently controlled heating zones. Each heating element 406 is independently controlled based on a set point input from the user so that the user can turn each heating element 406 on or off for specific container sections or areas via a touch switch or via the graphical user interface of the mobile device. This allows selective warming of only part of the container contents if desired.

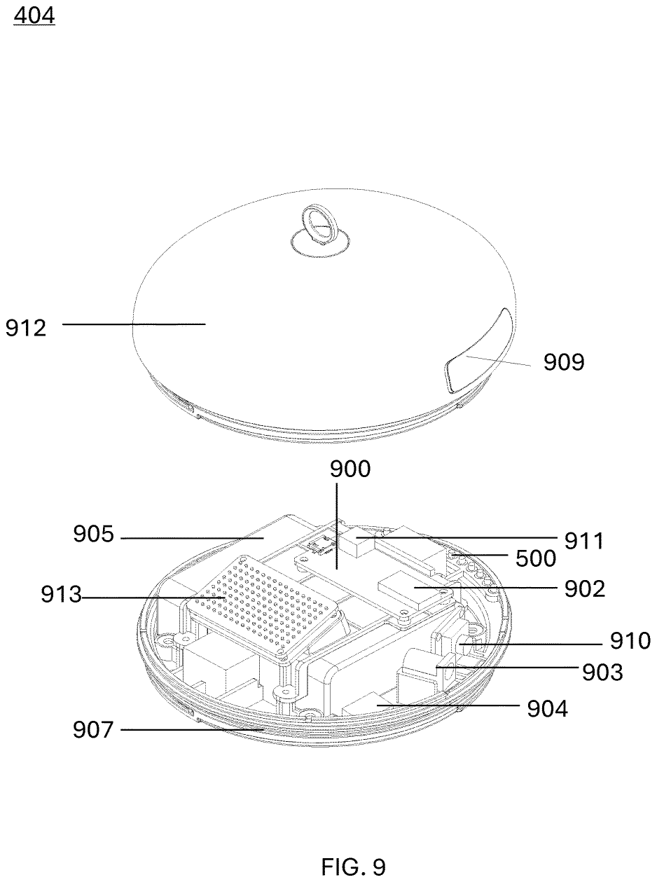

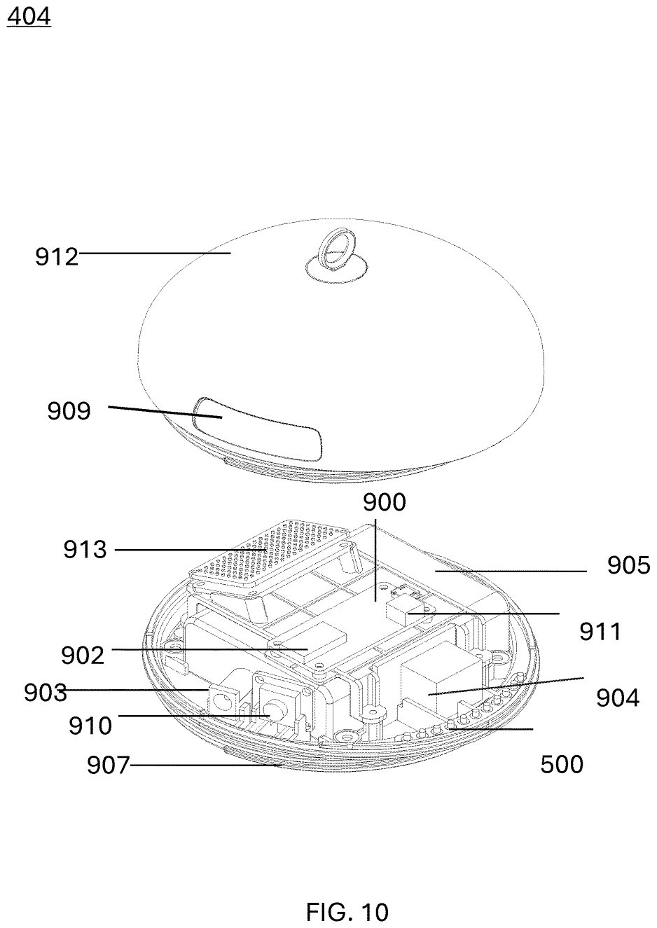

As noted above, the hot module 404 (both in this multi-container aspect as well as in the single-container aspect described with respect to FIGS. 1 through 3F) includes any components as may be necessary to implement the functions described herein. For example, and as shown in FIGS. 9 and 10, the hot module 404 includes a microcontroller unit (MCU) 900 coupled with a wireless transceiver 902. Also included are control circuitry and charging circuitry 903 for charging the battery, sensing and computing functions, providing graphical control features (e.g., driving a display or LEDs), as well as managing power delivery to the heating elements. In one aspect, a drive transistor 904 or other power switching device is included to accommodate the relatively large switching currents flowing from the electrical energy storage element to one or more resistive heating elements. The MCU 900 may execute software or firmware that manages operating modes, communication protocols, safety checks, and user-interface logic.

As referenced above, a wireless transmitter (e.g., transceiver 902) is included for transmitting and receiving information between the hot module 404 and a mobile device using Bluetooth® or any other applicable wireless technology. Thus, the user may wirelessly input a control command, such as a specific set temperature, heating schedule, or container selection, to the hot module 404 and monitor state information of the device 11. As shown in FIG. 19, the wireless transmitter or transceiver is configured to establish a secure communication connection with the mobile device 1900 and is configured to send detected temperature data, fault conditions, battery status, and other related information to and from the mobile device 1900 for controlling and monitoring the device 11 of the present disclosure. The wireless interface may support one-way or two-way communication and may permit firmware updates, diagnostic logging, and integration with broader smart-home or IoT ecosystems.

Further, the hot module 404 includes a power supply 905 (e.g., a rechargeable battery) configured to provide power as required to any of the components, including the temperature sensors, indicators, actuation switches, and heating elements. Also shown in FIGS. 9 and 10 are the contacts 500 for supplying power to the container(s) and heating elements and for obtaining information signals from the sensors. Threads 907 or other screw structures are also depicted to allow selective fastening of the hot module 404 to the container assembly. The power supply 905 can be sized and selected based on desired run-time, weight, cost, and recharge time considerations.

The electronic hot module 404 can automatically supply and shut off power to the heating element 406 based on the user's selected settings and real-time temperature data. To accurately reach a selected temperature or temperature range at a scheduled time, the module 404 may monitor ambient (room) temperature, predict the time required to heat the food from its current temperature, and limit power supply to the period during which heating is required. When the set temperature is reached, a visual indicator may inform the user that the reservation or scheduled heating period is in progress or complete. After completion, the system can reduce power, enter a standby mode, or maintain a lower-level holding temperature as desired. The system can be configured to heat at high power settings from about 15 to about 90 minutes before the scheduled time to offset the possibility of food remaining at intermediate temperatures for extended periods, thereby mitigating the risk of spoilage.

In another aspect, the electronic hot module 404 can automatically turn off power to the heating element 406 under certain battery conditions. For example, if the electrical energy storage level of the battery falls below a predetermined power level relative to the amount corresponding to full charge, the hot module 404 may turn off or reduce power to the heating element 406 to prevent excessive battery discharge and possible damage to the battery cells. This low-battery protection helps prolong battery life and enhance safety.

In another aspect, the hot module 404 can include circuitry with a thermal protection switch or other temperature-limiting device. In this aspect, when the system temperature rises above a predetermined high temperature limit, the thermal protection switch opens the circuit that electrically connects the hot module 404 and the heating element 406, thereby interrupting or reducing power to the heating element. In some implementations, the system may reduce the amount of power or control the power delivery using pulse width modulation (PWM) or similar techniques to maintain a safe operating temperature while still attempting to reach or maintain the desired food temperature. These protective mechanisms can prevent overheating, protect the container and surrounding components, and reduce the risk of burns or other hazards.

In another aspect, for immediate heating, the user can manually activate the heating system using a touch switch on the hot module 404 and deactivate it by touching the switch a second time. Using this “manual override” function, any previously reserved or scheduled setting may be ignored or temporarily suspended. However, if a lock function is activated via wireless control (for example, through the mobile application), the container's touch switch may be disabled, and the settings provided through wireless control may take precedence. This can be useful to prevent accidental activation or tampering, for example, in households with children.

As can be appreciated, any suitable user interface can be employed to provide the desired functional flexibility. For example, the hot module 404 can be configured to allow a user to select a desired temperature or desired temperature range (e.g., “low,” “medium,” or “high”) to be reached at the desired use time. Based on the settings entered through the user interface, the hot module 404 limits, modulates, or controls the power level based on the selected temperature or temperature range, thereby controlling the amount of power delivered to the heating element 406. The interface may provide feedback on current temperature, remaining time, battery level, wireless connectivity, and error conditions, and may allow the user to store favorite or preset programs for repeated use.

The hot module 404 can also be configured to include a user interface 909, such as an electrically responsive touch switch or touch-sensitive surface. When the touch switch is contacted, it senses the capacitance, resistance, or other electrical characteristic of the user's body and can immediately turn on or off the heating element 406 of the corresponding container 400. In one embodiment, the touch switch acts as a toggle switch, wherein the user can press and hold the button once to turn on the heating system and perform a second long press to turn off the system, thereby overriding any reserved or scheduled setting. Factory-set temperature levels may be provided as initial default values: for instance, a first set point (low), a second set point (medium), and a third set point (high). These can be cycled through by short touches, with a subsequent short touch returning to the first set point. When the set point is changed, and while the system is in standby or heating mode, operational information is fed back to the user via one or more light sources or visual indicators mounted in or on the hot module 404. These indicators can use different colors, flashing patterns, or brightness levels to convey different statuses.

When activated, the heating element 406 is energized until a predetermined temperature set point (e.g., low, medium, high, or a specific user-defined temperature) is reached, as determined by the temperature sensor(s) 1800 and the control algorithm. In some aspects, a buried push button switch or touch switch is used to maintain a smooth, continuous exterior surface for improved waterproofing, ease of cleaning, and enhanced aesthetics. Further, in some aspects, one or more buttons 910 located on the side of the hot module 404 have different functions and can be pressed to toggle between such functions. For example, one button may be dedicated to powering the hot module 404 on or off, while another button may be used to activate or display the BLUETOOTH® pairing mode, to initiate pairing with the mobile device 1900, or to scroll through menu options displayed on a graphical interface.

In some aspects, visual indicators 913 are provided in the hot module 404 and/or on the container 400. For example, when the heating element 406 of each metal container 400 is in standby mode or heating mode, operational information is displayed via one or more light sources or visual indicators 913. The visual indicators 913 may indicate operating conditions or parameters of the container system. Status information such as standby mode, active heating mode, completion or “ready-to-eat” mode, and fault or error conditions can be displayed. Additionally, information such as battery charge level, power level, wireless connection status, and selected temperature can be indicated, for example, using different colors, icons, numeric values, or animation patterns.

Examples of the visual indicators 913 include electroluminescent elements, organic light emitting diodes (OLEDs), edge-illumination devices, flat light emitters, digital or segment screens, and the like. In some aspects, the visual indicator 913 is located inside a plastic layer 912 and is substantially invisible when not activated, preserving a clean and seamless appearance. When the display or screen is activated by the hot module 404, it illuminates through a colored or translucent plastic layer 912. When the power switch located on the side of the hot module 404 is toggled, or when the hot module 404 is coupled to the container 400, a visual indicator may be automatically activated to indicate events such as BLUETOOTH® pairing status, power-on state, and battery charge level.

In another aspect, an audio output device can be included to provide auditory feedback. For example, the hot module 404 can be formed to generate audible sounds from a piezo speaker 911 or other sound-emitting component. Audible sounds or tones may be used to signal user inputs (e.g., when a button is pressed), confirm successful pairing or setting changes, indicate entry into standby mode, or notify the user when the set temperature or scheduled time has been reached. Different tones, patterns, or volumes can be used to distinguish between types of alerts (e.g., completion vs. low battery warnings).

As noted above, the hot module 404 is powered by a power supply 905, such as a rechargeable or removable battery pack. In one aspect, the battery pack is mounted on the bottom of the hot module 404 and has electrical contacts to supply power to the module 404. The electrical contacts may be protruding shapes —such as pins, pads, or strips—but can take other forms as well. The electrical contacts can be gold-plated electrical contact strips, but may also be made of other conductive and corrosion-resistant materials. In some aspects, the electrical contacts are symmetrically shaped or otherwise arranged so that the battery pack can be mounted in multiple orientations (e.g., 180-degree rotation) without causing errors in the electrical connection between the battery pack and the hot module 404. In yet another aspect, the detachable battery pack may have a hook-type or latch-type binding structure for accurate and secure coupling with the hot module unit, permitting easy removal for charging or replacement.

The power supply 905 (i.e., the battery) supplies power to the heating element 406 for any preset amount of time (for example, about 15 to about 90 minutes, depending on parameters such as the set temperature, ambient conditions, and the number of containers 400 being heated). The battery and control electronics manage power advantageously by waiting until a predetermined time before the scheduled usage to begin heating, and by supplying power to the heating elements only for the expected time required. The hot module 404 manages both the discharge and recharge processes to help maximize the life of the rechargeable battery. The hot module 404 can also monitor cell balancing, cell voltage, and discharging rates of the battery during charging or heating operations. The charging circuitry can control the charging operation to help ensure the long-term health of the battery, to prevent overcharge conditions, and to stop or reduce charging when the battery charge reaches its maximum capacity. If the discharge rate exceeds an allowable rate or if a condition indicative of potential damage or abnormal operation is detected, the hot module 404 may provide a visual and/or audible indication of reduced battery performance, may limit power output, or may shut down heating functions to protect the system.

The power supply 905 can be charged using any suitable charger or charging device. For example, the charger may receive power from a household electrical outlet, a vehicle power socket or “cigar jack,” a USB power source, or other external power supplies, convert it to direct current at an appropriate voltage, and connect it to the hot module 404 to supply electricity to the power supply 905 for energy storage. The charger is connected to the rechargeable battery via electrical contacts on the side or bottom of the hot module 404, and these electrical contacts can be hidden or covered by a silicone or elastomeric cover for safety, dust resistance, and waterproofing. The charger may be electrically connected to the external power source (such as a wall outlet) via an electrical cord or plug. Once the battery is sufficiently charged, it will supply power to the heating element 406 for a period of time even if the charger is disengaged from the electrical contacts, thereby enabling completely portable operation of the device.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A device for controlling food temperature, comprising:
a first insulated container having an interior volume configured to receive food, the insulated container including an inner wall, an outer wall spaced from the inner wall to define an insulating cavity therebetween, and a bottom wall defining at least a portion of a floor of the interior volume;
a lid configured to be removably coupled to the insulated container to cover an opening of the interior volume and to provide thermal insulation for the interior volume;
a hot module, the hot module including at least one heating element, a power supply configured to supply electrical power to the at least one heating element, at least one temperature sensor configured to generate a signal indicative of a temperature associated with food in the interior volume, and temperature-regulating electronics operatively coupled to the at least one heating element, the at least one temperature sensor and the power supply; and
wherein the temperature-regulating electronics are configured to control operation of the at least one heating element based at least in part on the signal from the at least one temperature sensor to regulate the temperature of food in the interior volume.

2. The device as set forth in claim 1, wherein the insulating cavity is at least one of (a) a vacuum cavity, and (b) filled with a thermal insulation material.

3. The device as set forth in claim 2, wherein the hot module is configured to be selectively attached to a connection cavity formed in a base of the insulated container.

4. The device as set forth in claim 3, wherein the connection cavity and the hot module include complementary threaded portions configured to releasably secure the hot module to the insulated container.

5. The device as set forth in claim 4, wherein the temperature-regulating electronics are configured to:
receive a target temperature;
compare the target temperature to a temperature determined from the signal from the at least one temperature sensor; and
control the at least one heating element to maintain the temperature of the food within a predetermined range of the target temperature.

6. The device as set forth in claim 5, wherein the temperature-regulating electronics are configured to execute a scheduled heating operation including:
determining a start time for heating based on an initial temperature associated with the food, and
energizing the at least one heating element beginning at the start time so that the food reaches a target temperature at a user-specified time.

7. The device as set forth in claim 6, wherein the temperature-regulating electronics are configured to operate the at least one heating element at a first power level for a pre-heating interval prior to a scheduled consumption time and at a second, lower power level to maintain the temperature of the food thereafter.

8. The device as set forth in claim 7, further comprising a wireless transceiver operatively coupled to the temperature-regulating electronics and configured to communicate wirelessly with a remote mobile device.

9. The device as set forth in claim 8, wherein the temperature-regulating electronics in conjunction with the wireless transceiver are configured to:
receive from the remote mobile device at least one of a target temperature, a heating schedule, or an operating mode; and
transmit to the remote mobile device at least one of a measured temperature, a battery status, or a heating status.

10. The device as set forth in claim 1, wherein the hot module is configured to be selectively attached to a connection cavity formed in a base of the insulated container.

11. The device as set forth in claim 10, wherein the connection cavity and the hot module include complementary threaded portions configured to releasably secure the hot module to the insulated container.

12. The device as set forth in claim 1, wherein the temperature-regulating electronics are configured to:
receive a target temperature;
compare the target temperature to a temperature determined from the signal from the at least one temperature sensor; and
control the at least one heating element to maintain the temperature of the food within a predetermined range of the target temperature.

13. The device as set forth in claim 1, wherein the temperature-regulating electronics are configured to execute a scheduled heating operation including:
determining a start time for heating based on an initial temperature associated with the food, and
energizing the at least one heating element beginning at the start time so that the food reaches a target temperature at a user-specified time.

14. The device as set forth in claim 1, wherein the temperature-regulating electronics are configured to operate the at least one heating element at a first power level for a pre-heating interval prior to a scheduled consumption time and at a second, lower power level to maintain the temperature of the food thereafter.

15. The device as set forth in claim 1, further comprising a wireless transceiver operatively coupled to the temperature-regulating electronics and configured to communicate wirelessly with a remote mobile device.

16. The device as set forth in claim 15, wherein the temperature-regulating electronics in conjunction with the wireless transceiver are configured to:
receive from the remote mobile device at least one of a target temperature, a heating schedule, or an operating mode; and
transmit to the remote mobile device at least one of a measured temperature, a battery status, or a heating status.

17. The device as set forth in claim 1, further comprising a second insulated container having an insulated interior and configured to receive food, the first insulated container and second insulated container configured to be selectively connected with one another.

18. The device as set forth in claim 17, wherein the at least one heating element includes a first heating element connected to the first insulated container and a second heating element connected to the second insulated container, and wherein the at least one temperature sensor includes a first temperature sensor connected to the first insulated container and a second temperature sensor connected to the second insulated container, such that the temperature-regulating electronics are configured to separately control operation of the first and second heating elements based at least in part on the signals from the first and second temperature sensors.

19. The device as set forth in claim 18, wherein a bottom part of the hot module includes electrical contacts that are configured to electrically connect with contacts formed on a top part of the first insulated container, while electrical contacts formed on a bottom of the first insulated container electrically connect with contracts formed on a top part of the second insulated container.
